(19) United States
(12) Patent Application Publication
(10) Pub. No.: US 2009/0138356 A1
(43) Pub. Date: May 28, 2009

(54) Systems and methods for content delivery

(75) Inventor: Kevin Pomplun, Palo Alto, CA (US)

Correspondence Address: CARR & FERRELL LLP, 2200 GENG ROAD, PALO ALTO, CA, 94303, US

(73) Assignee: Skygrid, Inc.

(21) Appl. No.: 12/319,314

(22) Filed: Jan. 5, 2009

Related U.S. Application Data
(63) Continuation-in-part of application No. 12/324,596, filed on Nov. 26, 2008.
Application No. 12/324,596 is a continuation of application No. 11/843,813, filed on Aug. 23, 2007, now Pat. No. 7,464,003.
(60) Provisional application No. 60/823,478, filed on Aug. 24, 2006.

(51) Int. Cl. G06Q 30/00; G06F 7/06; G06F 17/20; G06F 17/30

(52) U.S. Cl. 705/14; 707/2; 707/4; 704/8

(57) ABSTRACT

A method is provided of determining the how information from any information system changes over time. WebPages A through WebPages Z with nodes A through Z, are located, where A through Z are integers. Timestamp values for each of a node from A through Z are retrieved. Timestamp values from A are subtracted to create a denominator time value. A distance between the nodes A through Z is determined by calculating a number of edges in the digraph to create a numerator value. The distance is divided by the denominator time value to provide a velocity value.

### CROSS-REFERENCE TO RELATED APPLICATIONS

This continuation-in-part application claims the benefit and priority of U.S. patent application Ser. No. 12/324,596 filed on Nov. 26, 2008, titled “System and Method for Change Detection of Information or Type of Data,” which is a continuation application claiming the benefit and priority of U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which claims the benefit and priority of U.S. Provisional Patent Application Ser. No. 60/823,478 filed on Aug. 24, 2006, titled “Dynamic Information System,” all of which are hereby incorporated by reference.

### BACKGROUND OF THE INVENTION

This invention relates generally to systems and methods for determining how information from any information system changes over time, and more particularly, determining how information from the internet changes over time.

### DESCRIPTION OF RELATED ART

Technology development has centered around the Internet for the past decade, and almost a billion people are currently online. One of the leading developments continues to be information retrieval. Leading search engines let users search through 10's of if not 100's of billions of documents and return results judged by some metric of relevance. The leading commercial search engines have become very good at matching keywords and analyzing link structure to determine how relevant a result is to a user. The online advertising business has also steered the technology away from some of the more traditional academic foci for information retrieval and focused on how to monetize keywords.

Today the criteria for a good search engine is relevance. Relevance is a fuzzy word and does not let you know if a document has a negative or positive connotation or if that document is reaching more or less people. Since the beginning of civilization, people have made decisions based on how good or bad something is and based on how many people are aware of the information. It seems odd that such critical information would be missing from search engines, but this is a result of commercial focus on keywords.

Precision, recall, fallout, accuracy and error are all metrics used to determine how well an information retrieval system works. Initially, search engines would return based just on words, then on citation ranking and currently are focusing on ranking algorithms. All of these approaches have used the five metrics of precision, recall, fallout, accuracy and error with a focus on a single independent variable—keyword. By using new independent variables, a much richer understanding of information is available.

There is a need for systems and methods that compute changes in information over time. There is a further need for systems and methods that provide a computable way to globally determine any change in any type of data.

### SUMMARY OF THE INVENTION

Accordingly, an object of the present invention is to provide systems and methods that compute changes in information over time.

Another object of the present invention is to provide systems and methods that accept any input from any system and quantifies its physical or quantum state.

Yet another object of the present invention is to provide systems and methods that determine the state space and its transitive state space shifts for any data.

A further object of the present invention is to provide systems and methods that see any change for any type of data and have a unique view of the series of events that define an object.

These and other objects of the present invention are achieved in a method of determining how information from any information system changes over time. WebPages A through WebPages Z with nodes A through Z, are located, where A through Z are integers. Timestamp values for each node from A through Z are retrieved. Timestamp values from A are subtracted to create a denominator time value. A distance between the nodes A through Z is determined by calculating a number of edges in a digraph to create a numerator value. The distance is divided by the numerator value to provide a velocity value.

In another embodiment of the present invention, a method is provided of determining how information from the internet changes over time. At least a first webpage with a first node and a second webpage with a second node are located. A first time stamp value is retrieved of when the first node was published. A second time stamp value is retrieved of when the second node was published. The second time stamp value is subtracted from the first time stamp value to create a denominator time value. A distance is determined between the first and second nodes. The distance is divided by the denominator time value to provide a velocity value.

### BRIEF DESCRIPTION OF THE DRAWINGS

FIG. 1 is a flow chart illustrating gathering information and assigning sentiment value.

FIG. 2 is a flow chart illustrating gathering information and assigning sentiment value that first gathers webpages from the Internet and puts each unique webpage in a file.

FIG. 3 is a flow chart illustrating matching all neutral to positive ads in an ad server with topic or entities from a web page.

FIG. 4 is a flow chart illustrating computing a correlation between source sentiment and factual sentiment to output an SSI score.

FIG. 5 is a flow chart showing an exemplary method for delivering content.

FIG. 6 is a diagram of an exemplary architecture of a system for content delivery.

FIGS. 7A and 7B illustrate exemplary screenshots of a display on a user digital device interacting with some of the various embodiments disclosed herein.

FIG. 8 shows a second exemplary screenshot of a display on a user digital device interacting with some of the various embodiments disclosed herein.

FIG. 9 is a flow chart showing another exemplary method for delivering content.

FIG. 10 illustrates an exemplary screenshot of a display on a user digital device interacting with one of the embodiments illustrated and discussed in connection with FIG. 9 herein.

### DETAILED DESCRIPTION OF THE INVENTION

The present invention is a program that measures information physics. The system (“InformationVelocity”) includes seven separate modules, all of which at the final time of filing may be considered separate inventions, for different systems and methods of scoring data in a linked database. Each module provides an input or output to help determine the physics of any piece of information. Information physics are determined by 1) intelligent crawling agents; 2) virtual graphs built within the database; 3) velocity engines; 4) sentiment engines; 5) closewords; 6) offline retrieval systems and 7) time deterministic systems.

The first module, ICA, or intelligent crawling agent, is a webcrawler that uses a set of learned criteria to retrieve the sources of data that are used by the rest of the system. The InformationVelocity system begins by spawning a process called Info_{—}2_System that aggregates two types of data structures. The first data structure type is RSS, which passes XML content to the system of the present invention. The second data structure type is Atom, which also passes XML content to the system of the present invention. This is called a pull process, because the system pulls content from different online information sources into the system of the present invention.

In another embodiment of the present invention, the InformationVelocity system collects anything without an RSS or Atom data structure by crawling. Any content source that does not export data anywhere outside of its immediate url, is considered crawlable by the InformationVelocity system.

The first part of any information source collected is the “SRC” or root url for the information source. In traditional web terminology this has also been called a homepage. From the root url, the present invention can collect more information about the SRC.

The second part of any information source collected are the “NIs” or News Items. It is a single, identifiable piece of information that is created by and hosted by the owner of the SRC. “NIs” are always a subset of the SRC. Each information source can only have one SRC or root url and from there a user can navigate to all of the “NIs”. Using the magazine Time as an analogy, the publication title “Time” would be the SRC (always stays the same) and all of the articles would be “NIs” (constantly being added to).

The second module is the virtual graphs built within the database, the SRCs provide nodes to build a graph of all of the root urls and the NIs provide nodes to build a graph of all of the new information that is created frequently by these sources.

The system of the present invention is built vertically. The vertical design allows the information indices to be built upon more precise criteria. For example, the system of the present invention can build a finance index vertically from the RSS, Atom and crawled content from within the financial domain. By using our sentiment engines (referred to below as the fourth module) we're able to determine if a particular type of data would usually be considered to be part of a domain. For example, root url of Tim Berners-Lee weblog is usually considered to be part of the technology domain.

In another embodiment of the present invention, InformationVelocity finds all matching NI to the query the user enters into the interface, stored in the database as a <stormId>, and then starts building a graph. This “NI graph” shows which NIs (all sharing the common value of containing some information related to the <stormId>) are connected and how they are connected. The NI connections are known as links in the present invention.

The first of two links used to build the “NI graph” is an inbound link. If the InformationVelocitySystem retrieves an NI, which is written at a first NI and in this NI, the present invention links to a second NI (for example an NI suggesting “have you read Tim Bemers-Lee's thoughts on Net Neutrality, you can do so by clicking here— . . . ”), and Tim Berners-Lee weblog would be the recipient of an inbound link from the present invention. With two NIs and the direction of which NI is connecting to the other NI, the present invention creates a digraph. The first NI would be Node_A and the second NI would be Node_B. It is obvious that Node_A is referencing Node_B and that makes Node_B the recipient of an inbound link from the agent Node_A. This gives the system of the present invention an ordered pair of vertices (Node_A, Node_B) with an edge Directed from Node_A to Node_B.

The second of two links used to build the “NI graph” is an outbound link. If the InformationVelocity_System retrieves an NI with a first url and in this NI, the first url contains a link to a second url, the present invention creates an outbound link from the first url to the second url.

In another embodiment of the present invention, the “NI behavior” module looks at all activity for each node in the “NI graph.” The present invention looks at how the number of comments to an NI change over time, how javascript changes over time, and how the structure of the page changes.

In another embodiment of the present invention, the “SRC quantity” uses a synchronous process to retrieve information about how many users the information source reaches, how the information source ranks relative to other information sources and several other types of information based on quantitative metrics. The “SRC quantity” only relates to the SRCs, or root urls.

In another embodiment of the present invention, a “SRC graph” is created. The “SRC graph” is less granular than the “NI graph”. A lot of the information sources that the present invention looks at display the other information sources that are referred to. Based upon this information, when the present invention builds a graph, “node clusters” become apparent. Just as in sociology, what is referred to as “Dunbar's number”, certain thresholds of interactivity between information sources called “node clusters” can be viewed.

In another embodiment of the present invention, the InformationVelocity_System creates a semantic index. Within the semantic index, the InformationVelocity_System calculates different properties of the semantic data in order to provide the algorithm of the present invention more outputs to better classify the information. For example, by recognizing the average frequency of a word across all of our information sources, the present invention can create and compare the historical mean to the most recent frequency of the word and determine a relative weight for the information (similar to Zipf's law distributions). The present invention also can measure levels of use activity at the information source level and from our system. From this data, the InformationVelocity_System can use pattern recognition to determine different levels of importance.

In accordance with yet another implementation consistent with the present invention, the third module, velocity engines, are a method for using virtual graphs to determine the speed and direction information is traveling over time.

In another embodiment of the present invention, the “NI velocity” module computes the velocity of an NI. Velocity equals distance divided by time (v=d/t). The denominator time, is determined by retrieving the timestamp from a 1st information source indicated by a series of different tags. For example, Atom uses <issued>, <created> and <modified> tags to give three different times. The present invention then retrieves the timestamps from a second information source and calculates the difference between the two. The numerator, or distance, is computed by the number of edges between nodes. The present invention can see how fast information is traveling between information sources as well as how fast a <stormId> is traveling from the calculated velocity data. The system of the present invention is capable of looking at two different <stormId> queries and comparing their velocity with our StormWatch application, in order to see which query is moving faster.

In another embodiment of the present invention, “SRC velocity” takes a node cluster and measures its rate of expansion or contraction. For example, if the present invention can see that a node cluster has historically had 10 members and today has 12, then it knows the rate of expansion has increased. Because of this increase in the rate of expansion, the InformationVelocity_System gives more weight to a <stormId> query that is part of an expanding node cluster. The system of the present invention gives more weight because it indicates that the information is significant enough to change the graph structure for the SRCs.

In another embodiment of the present invention, applying differential geometry, group theory and dynamical systems theory determine how the graph changes over time.

In another embodiment of the present invention, the fourth module, NLP engines are Natural Language Processing modules. The present invention uses a series of modules to create a rules based system that can determine context. There are many main parts to the “NLP modules” used in the system of the present invention.

The first part of the “NLP module” system is a parser that retrieves a section of text from an information source and determines which parts of speech are found in each sentence. For example, the parser reads the phrase “great ideas grow endlessly” as “(S:(NP:(ADJ: Great) (NOUN: ideas)) VP: (VERB: grow) (ADV: endlessly)))). Another part of the “NLP module” system is the feature database. Based upon the results of the parsing process different parts of text will start to create “features”. A feature is just a way to put information into a very specific classification. For example, the above sentence, “great ideas grow endlessly,” would generate a feature “ideas-nns-amod-great-jj. This feature is then assigned a tag of “good” and when the InformationVelocity_System reads any new information with a matching feature “ideas-nns-amod-great-jj”, the new information would be assigned a tag of “good” as a result.

Another part of the “NLP module” system is the feature classification process. The feature classification process determines whether features are classified as good, bad or neutral. Within this classification a gradient score determines how good or how bad or how neutral the features are. The gradient scores range from 0.0000 to 1.0000. For example a feature could be determined to be 0.8 good+0.2 neutral. The final part of the “NLP module” system is the sentence classification process. At the feature level, it is most common to have a single score (ie 1.0 good). At first glance this would seem that the system is oversimplifying context, but remembering that many features make up a sentence, leads to the need for a sentence classification process. For example if you have a sentence with three features, feature one is 1.0 good and features 2 and 3 are both 1.0 bad, then you have a sentence classification as 0.3333 good (1.0 out of 3.0 total) and 0.6666 bad (2.0 out of 3.0 total).

In another embodiment of the present invention, the fifth module, CloseWords, determines interesting words related to a user query. On a Cartesian coordinate plane, a user query is generated as an ideal (with xy coordinates (1,1)). The x value is the number of results and the y value is the number of times the query appears in the result set. Many natural language processing systems have used the tf-idf (term frequency—inverse document frequency) metric to determine other outputs. By comparing the ideal coordinates of (1,1) with each member of the result set coordinates, the words that are closest are determined to be CloseWords.

In another embodiment of the present invention, the sixth module, offline retrieval system, is a system for accessing all information available to the instant the user stopped being online, while offline. The system includes locally storing a database of all information in InformationVelocity on a user's local machine and making the information available offline. The user can receive all information from InformationVelocity as if she or he were online and time had stopped at the instant she or he was no longer online.

In another embodiment of the present invention, the seventh module, time deterministic systems, a method for determining how any information has changed over time; determining information about any content source at an initial point in time, later determining information about any content source at a later point in time; computing the difference the same piece of information has at two points in time to determine any changes. In accordance with a further implementation consistent with the present invention, a method for determining time changes for any information source by generating Minkowski spaces. Specifically Bloch spheres are determined as coordinates of a particular piece of information at a given instant. Determining all vectors for any information source, all state spaces from origin to present are generated, and the complete set determines the time-change manifold. Generating separate spacetime instances gives a surprisingly simple way to determine complex behavior and information physics.

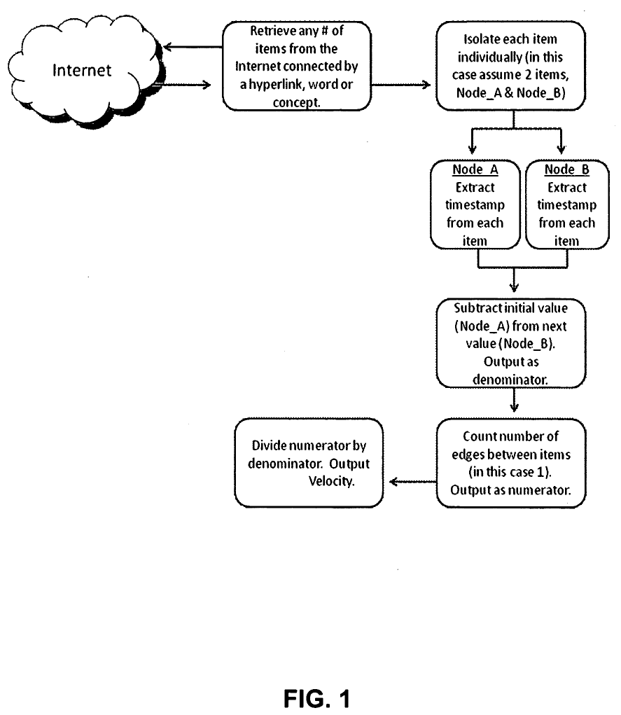

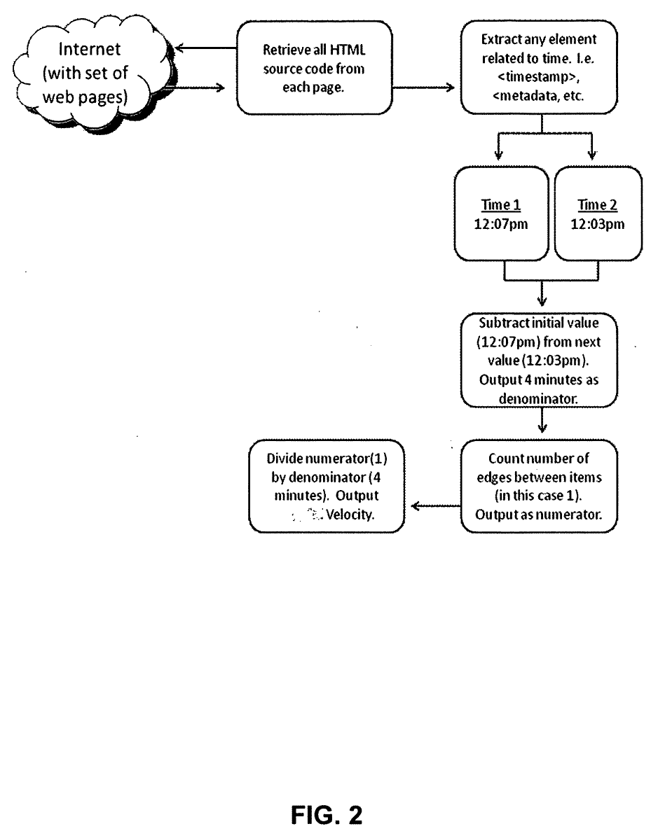

Referring to the flow charts of FIGS. 1 and 2, a method is provided for determining how information such as text, audio, photographs, video, any transmission of any type from any information system, including but not limited to the internet, RFID, UPC, and any form of data changes over time. Examples of changes include, but are not limited to, growth, decay or maintenance of, or any other physical or quantum state, and the like. FIG. 1 shows a system for gathering information and assigning sentiment value. The system first gathers webpages from the Internet (it can gather data from any information source), then puts each unique webpage in a file. From these files it extracts the timestamps when each page was published or updated. The timestamps are then subtracted from each other to compute the denominator of a fraction. The number of pages are then subtracted from each other to compute the numerator of the said fraction. The fraction is then resolved to a single value to show the InformationVelocity.

In one embodiment, web pages A through WebPages Z are located with nodes A through Z, where A through Z are integers.

From these files it extracts the text and creates a sentiment pair consisting of a sentiment, and an object. For example, a page positively describing the programming language Python, would extract a pair indicating the sentiment was “positive” and the object was “Python”. The pair would have an appearance as follows: (positive, Python). The object in the page (in this case “Python”) is then matched with an ad relevant to the object. The matched ad is then sent to another webpage using ads technology to display ads about that other webpage.

Computer software is used to collect each webpage and make it available to store, search, organize, edit, publish, share, view, or being transmitted in any other form. In this instance, each webpage is determined to be a node. Timestamp values are retrieved for each node from A through. Z. From each node the source code (or in other instances any form of where information about time is stored) is retrieved and the timestamp is extracted. Timestamp values are extracted from A to create a denominator time value. In one embodiment, <issued>, <created> and <modified> tags and other indication of time is used to determine the timestamp. It will be appreciated that other methods can be utilized to determine the timestamp including but not limited to using a sitemap protocol to gather XML tags, nothing that all data values in a sitemap must be entity-escaped and the file must be UTF-8 encoded, and the like. Examples of these tags could include <lastmod>, <changefreq>, and any other indication of time.

A distance between the nodes A through Z is then determined by calculating the number of edges in the digraph to create a numerator value. The numerator value is then divided by the denominator to provide a velocity value.

In one embodiment, the velocity value is used to determine how a producer, receiver, observer or transmitter, or object, event, or agent of information changes over time.

In another embodiment, the velocity value is used to determine how consumers of information change over time.

In one embodiment, first and second nodes are located at first and second webpages respectively, as illustrated in the first flowchart above. A first timestamp value of when the first node was published is retrieved and a second timestamp value of when the second node was published is also retrieved, as illustrated in FIG. 2.

Again, by subtracting the second time stamp value from the first time stamp value, a denominator time value is created. A distance between the first and second nodes is determined. By dividing the distance by the denominator time value a velocity value is created.

It will be appreciated that time stamps from more than two web pages can be retrieved. The distance is the shortest distance between the first and second nodes. The number of edges between the first and second nodes is determined.

In various embodiments, the velocity value is a velocity of RFID's, supply-changing logistics, consumer packaged good purchase rates, UPC, advertisements, operating systems, computer applications, mobile information systems, networks, interactive video game devices, game consoles, game controllers and software for operating games, videos, photographs, audio, digital media in any form, any electronic transmission of information, and the like. In another embodiment, advertisements can be created.

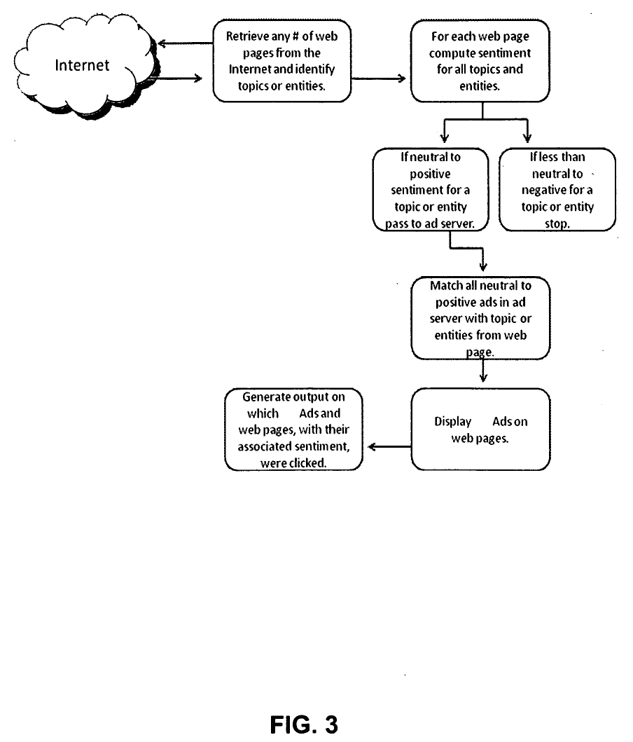

In this embodiment, illustrated in FIG. 3, the system creates advertisements by identifying sentiment information for an advertisement, analyzing the content of a target document to identify the sentiment of a list of one or more topics for the target document, comparing the targeting information to the list of topics to determine if sentiment exists, and determining that the advertisement is relevant to the target document if the sentiment is of a neutral to positive classification and irrelevant if negative.

The system for creating the advertisements involves methods and apparatus for determining advertisements that have sentiment and have neutral to positive sentiment for a given document. Alternately, advertisements that have negative sentiment or documents that have negative sentiment will not have any ads displayed, and will be classified as negative sentiment destinations. In one implementation, the document is a web page and the advertisements are electronic files that are capable of being rendered on that web page. A set, such as a list, of sentiment topics corresponding to the web page is generated by analyzing the sentiment of the web page. The list of sentiment topics is compared to target sentiment information associated with the advertisements (e.g. advertisements classified by degrees of neutral to positive sentiment) to determine which of the advertisements are neutral to positive in sentiment for the web page. Some or all of these sentiment classified advertisements may then be associated with the web page so that they may be rendered (e.g., displayed) with the web page.

The system for creating the advertisements ensures advertisers only advertise where they receive positive responses and attention.

Additionally, the system for creating the advertisements can determine increasing positive sentiment for their own ads, and use the rate of increase as an indicator of which web pages are most valuable to place ads on. Similarly, the system for creating the advertisements can inform advertisers about any other company's sentiment relative to their own, and they can determine purchasing thresholds, frequencies and any other dynamic value to govern their activity, to place ads on web pages.

In another embodiment, Source Influence can be created.

Source Influence is an information system, architecture, and algorithm to determine the factual accuracy and reliability of any content generator over time.

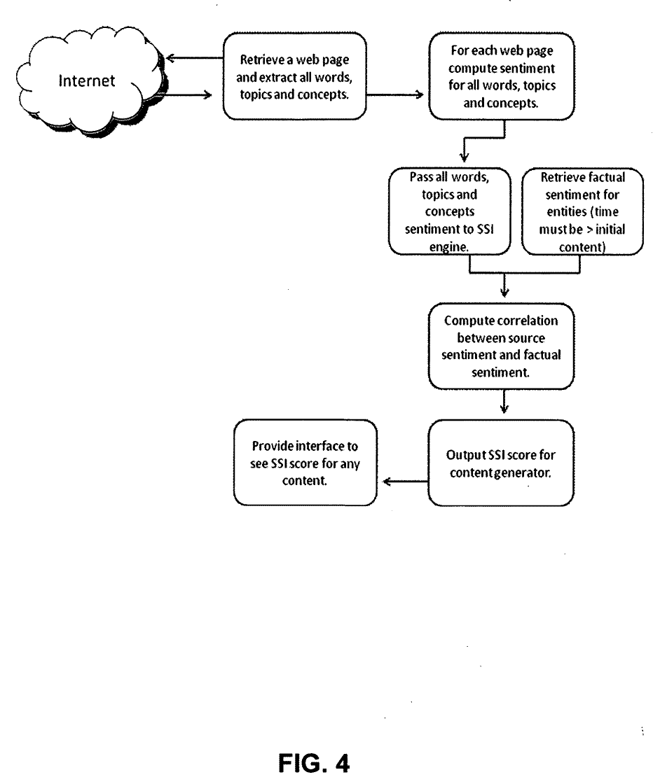

By applying Sentiment, the system can determine how often the Sentiment from the content generator is accurate and reflects the factual occurrences about the content, as shown in FIG. 4.

Source Influence retrieves any type of content and then extracts a set of words, topics, and concepts. Each word, topic or concept is given a Sentiment score based on the sentiment present in the content generated. For example, if a content provider (e.g. The Wall Street Journal) suggested that a company (e.g. Nintendo) would outperform another company (e.g. PlayStation) in console sales, SSI would first determine Nintendo's Sentiment (mostly positive) relative to PlayStation's Sentiment (mostly negative), and both relative to the topic identified (i.e. console sales).

Source Influence stores the words, topics, and concepts and then provides the matching of those entities with the factual events. In this example, the Sentiment from The Wall Street Journal article would then get compared to the console sales in the window of time suggested by the content. If The Wall Street Journal was correct, it would receive an increased Source Influence Score. If The Wall Street Journal was incorrect, it would receive a decreased Source Influence Score.

Over any window of time, Source Influence can provide access to an information system that would determine the entire range of Source Influence scores for any content generators selected. Any content generator at any point in time, at any geographic location, would be instantly able to display its Source Influence. Similarly, any content reviewer would be able to view the same information.

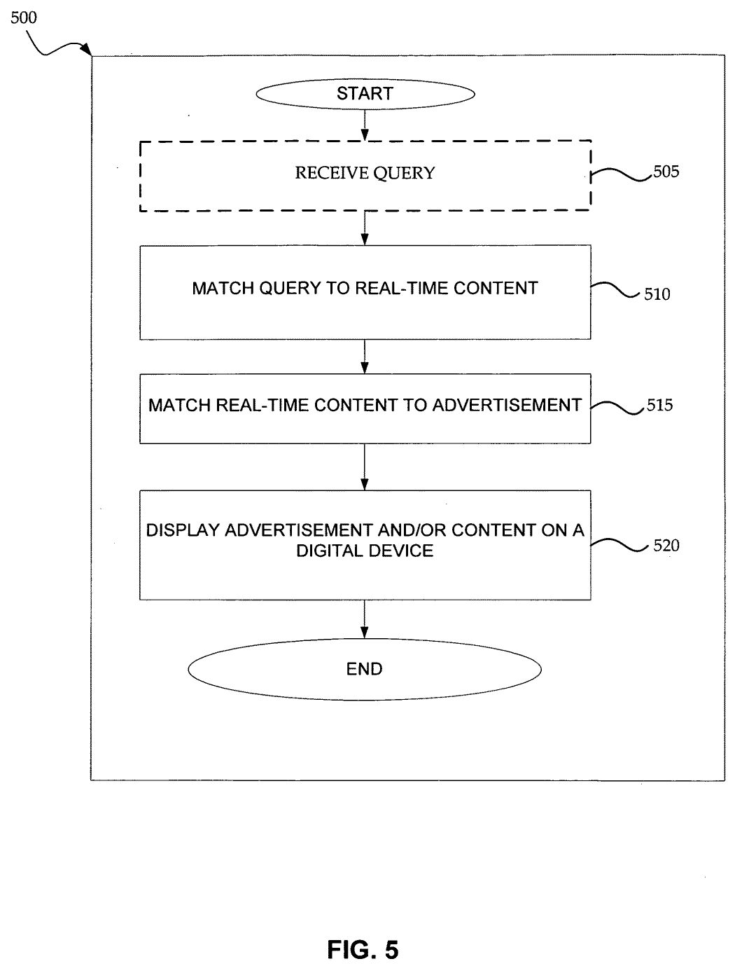

FIG. 5 is a flow chart showing an exemplary method 500 for delivering content.

At optional step 505, a query is received. According to various exemplary embodiments, the query may be received by one of the systems described herein from a digital device. The received query may be a company name, a name of an event, a stock ticker, a sector name, an industry name, a group name, a product name or any word.

At step 510, the query is matched to real-time content. In one exemplary embodiment, the real-time content may comprise digital content matched or selected to the query due to the real-time content having a predefined velocity value or a predefined component of velocity value. For example, the matched or selected real-time content may have been generated, edited, or modified at the same time, at nearly the same time, or shortly after the time the query was received. The matched or selected real-time content may comprise text, audio, video, html links, or any combination thereof matched or selected due at least in part to the timely relevance of the content.

According to further exemplary embodiments, the real-time content may be matched or selected due to the real-time content having a particular characteristic, such as blog content, news wire content, advertising content, or any combination thereof. The real-time content may be matched or selected due to a type of language used in the real-time content, such as French, Japanese, Chinese, German, English or any combination thereof. The real-time content may be matched or selected due to the type of device used to submit the query at step 505. For example, the device used to submit the query might be a computing device, a laptop computer, a desktop computer, or a mobile communications device. The real-time content may be matched or selected to accommodate the characteristics of the specific device, such as screen size, bandwidth, memory and the like. Alternatively, the real-time content may be matched or selected based upon a location of the device submitting the query. For example, a query may be received from a mobile communications device that includes a location identifier, such as a GPS position. The corresponding real-time content may be matched or selected due to at least in part to the geographical relevance of the content.

At step 515, the real-time content is matched to content. In this particular example, the real-time content is matched to an advertisement. According to one exemplary embodiment, a sentiment is computed that corresponds to a topic associated with the matched or selected real-time content. This sentiment may be utilized to match or select content (e.g., an advertisement) related to the topic associated with the matched or selected real-time content. For example, the matched or selected real-time content may be a news article about the mobile phone industry announcing it has just reached three billion subscribers. A sentiment may be computed for the topic of mobile phone sales. Accordingly, the computed sentiment may be used to match or select an advertisement for a particular new mobile phone that has 24 GB of storage and that has outstanding 4G capabilities.

At step 520, the matched or selected content (in this example, an advertisement) is displayed on a digital device. Such a display may also include displaying at least a portion of the matched or selected real-time content. For instance, the advertisement for the mobile phone with 24 GB of storage and outstanding 4G capabilities as described at step 515 may be displayed on an Apple iPhone. At least a portion of the news article described at step 515 may also be displayed on the Apple iPhone in close proximity to the advertisement. According to a further embodiment, a determination may be made as to whether the advertisement and/or real-time content was accessed or clicked on by the user of the digital device. Data may be generated describing the advertisement and/or real-time content accessed or clicked on. Further, a sentiment may be computed corresponding to a topic associated with the advertisement and/or real-time content.

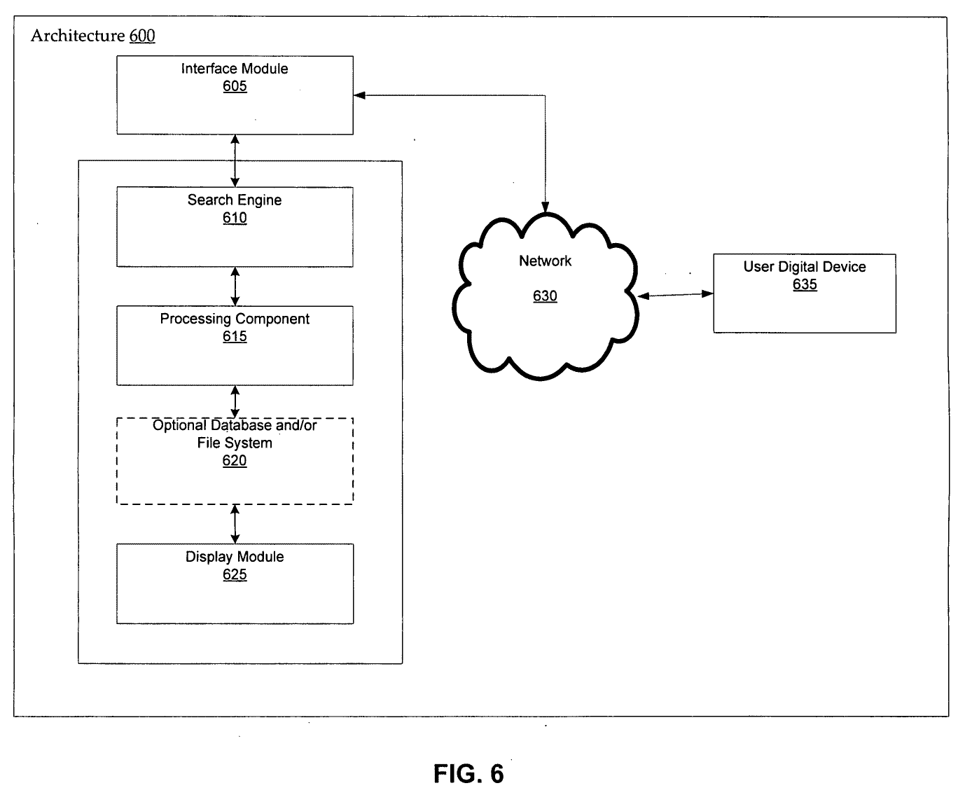

FIG. 6 is a diagram of an exemplary architecture 600 of a system for content delivery. The exemplary architecture 600 includes an interface module 605, a search engine 610, a processing component 615, an optional database and/or file system 620, a display module 625, a network 630, and a user device 635.

According to one exemplary embodiment, the interface module 605 is configured to receive a query via the network 630. The query may be received from a digital device, such as the exemplary user digital device 635. The query may be manually entered by a user of the digital device, or the query may be automatically generated and sent by the digital device. For example, the digital device may be programmed to automatically send a query such as a location identifier to a system for content delivery such as the one illustrated in FIG. 6. The received query may also be a company name, a name of an event, a stock ticker, a sector name, an industry name, a group name, a product name or any word.

The search engine 610, in one exemplary embodiment, is in communication with the interface module 605. For example, the interface module 605 may communicate a received query to the search engine 610. The search engine 610 may match or select the query to real-time content. In one exemplary embodiment, the search engine 610 may match or select a query to real-time content due to the real-time content being generated by a person other than the person that submitted the query, and the real-time content being generated directly in response to the submitted query. For example, person “A” may submit a query for “the best ice cream in Hawaii” and person “B,” having seen person “A's” query, may type a response, such as “Joe's Ice Cream Shop in Honolulu.” Accordingly, the search engine 610 may match or select person “A's” query to the real-time content generated by person “B.” According to a further embodiment, the search engine 610 may match or select a query to real-time content due to the real-time content being generated by a person in the same social group or social graph as the person that submitted the query. For example, person “A” may submit a query and the search engine 610 may match or select real-time content generated by person “B” to person “A's” query because person “B” has a predefined social relationship (e.g., friend, colleague, classmate, etc.) to person “A.”

According to various exemplary embodiments, the processing component 615 is in communication with the search engine 610. The processing component 615 may match the real-time content provided by the search engine 610 to other content, such as an advertisement. For example, the processing component 615 may compute a sentiment that corresponds to a topic associated with the matched or selected real-time content. This sentiment may be utilized to match or select content (e.g., an advertisement) related to the topic associated with the matched or selected real-time content. The content, such as an advertisement, may be sourced from a variety of locations within or outside of the exemplary architecture 600, including the optional database and/or file system 620.

The optional database and/or file system 620, in one embodiment, may comprise a computer readable storage medium having content stored thereon (e.g., advertisements, text, audio, links, video and/or combinations thereof). The processing component 615 may match real-time content to some or all of the content in the optional database and/or file system 620. The content in the optional database and/or file system 620 may be selected and stored in anticipation of opportunities to be matched by the processing component 615 to real-time content. For example, with respect to the advertisement for the mobile phone with 24 GB of storage and outstanding 4G capabilities as described in connection with FIG. 5 herein, such an advertisement may be provided by the mobile phone manufacturer and stored in the optional database and/or file system 620 in anticipation of an event, such as the news article about increased mobile phone sales.

In various exemplary embodiments, the display module 625 is in communication with the processing component 615. The display module 625 may cause the display of content (e.g., an advertisement) on a user device, such as user digital device 635. Such a display may also include the display of at least a portion of the matched or selected real-time content (e.g., a press release).

The user digital device 635, according to various embodiments, is a networkable digital device. The user digital device 635 may communicate over the network 630 with an interface module, such as the exemplary interface module 605. The network 630 may be the Internet, a mobile network, a local area network, or any combination thereof. The user digital device 635 may be a desktop computer, laptop computer, mobile communications device, music player, game console, GPS device, networked sensor, card key reader, credit card reader or other digital computing device.

It will be appreciated by one of ordinary skill that examples of computer readable storage medium may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

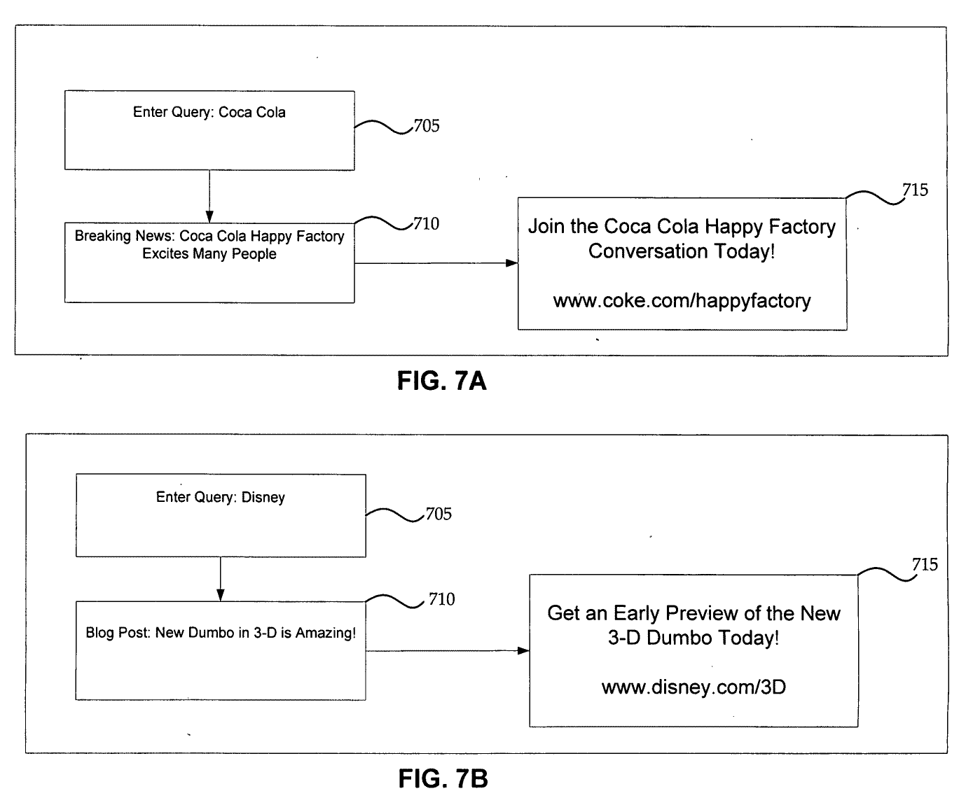

FIGS. 7A and 7B illustrate exemplary screenshots of a display on a user digital device interacting with some of the various embodiments disclosed herein. FIGS. 7A and 7B show a query screen 705, a real-time content screen 710 and a content (i.e., advertisement) screen 715.

According to one exemplary embodiment, a query may be entered on query screen 705. In the example shown in FIG. 7A, the query “Coca Cola” is entered on the query screen 705. In the example illustrated in FIG. 7B, the query “Disney” is entered on the query screen 705. The query may be entered by a user of a user digital device, such as the exemplary user digital device 635 (FIG. 6). Alternatively, the query may be automatically generated per a program and sent by the user digital device.

The real-time content screen 710, according to various exemplary embodiments, displays real-time content. In the example illustrated in FIG. 7A, the real-time content displayed by the real-time content screen 710 is “Breaking News: Coca Cola Happy Factory Excites Many People.” In the example illustrated in FIG. 7B, the real-time content displayed by the real-time content screen 710 is “Blog Post: New Dumbo in 3-D is Amazing!” The real-time content may be provided by a search engine, such as the exemplary search engine 610 (FIG. 6), processed by a processing component, such as the exemplary processing component 615 (FIG. 6), and configured for display by a display module, such as the exemplary display module 625 (FIG. 6) for display on the real-time content screen 710.

According to one exemplary embodiment, the content screen 715 displays content, such as advertisements. In the example illustrated in FIG. 7A, the advertisement displayed by the content screen 715 is “Join the Coca Cola Happy Factory Conversation Today!” The content screen 715 as shown in FIG. 7A also displays “www.coke.com/happyfactory,” which corresponds to an html link that may be activated by a user of the user digital device. In the example illustrated in FIG. 7B, the advertisement displayed by the content screen 715 is “Get an Early Preview of the New 3-D Dumbo Today!” The content screen 715 as shown in FIG. 7B also displays “www.disney.com/3D,” which corresponds to an html link that may be activated by a user of the user digital device. The content shown in both content screens may be generated by a processing component, such as the exemplary processing component 615 matching or selecting content found in a database and/or file system, such as the optional database and/or file system 620 (FIG. 6), for display on the content screens.

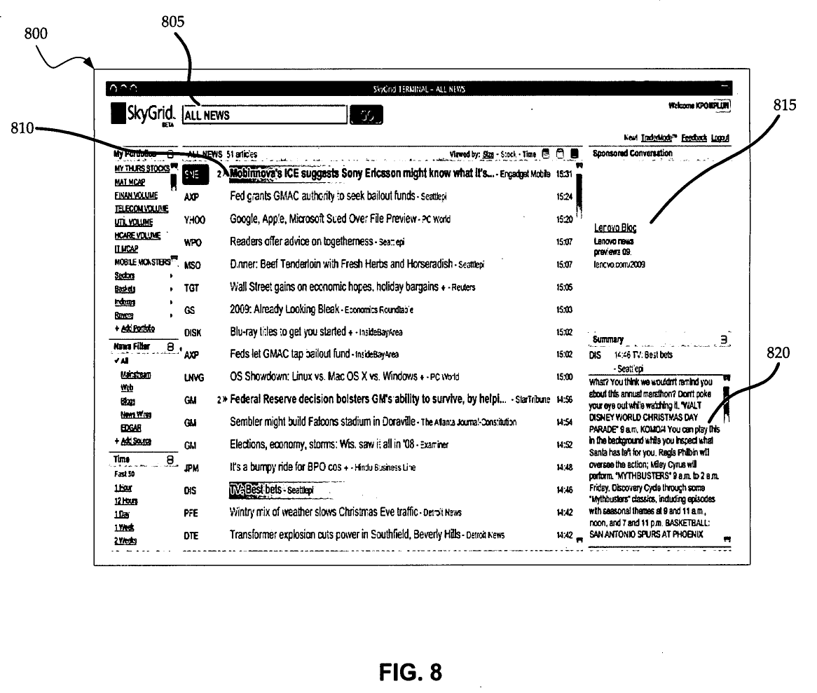

FIG. 8 shows a second exemplary screenshot 800 of a display on a user digital device interacting with some of the various embodiments disclosed herein. FIG. 8 includes a query screen 805, a real-time content screen 810, a content (i.e., advertisement) screen 815, and a real-time content view screen 820.

According to one exemplary embodiment, a query may be entered on the query screen 805. In the example shown in FIG. 8, the query “All News” is entered on the query screen 805. The query may be entered by a user of a user digital device. Alternatively, the query may be automatically generated per a program and sent by the user's digital device.

The real-time content screen 810, according to various exemplary embodiments, displays real-time content. In the example illustrated in FIG. 8, the real-time content displayed by the real-time content screen 810 includes multiple headlines, including “Mobinnova's ICE suggests Sony Ericsson might know what it's [worth].” In the example illustrated in FIG. 8, the headlines may include a designation of sentiment associated with the headline. For instance, the sentiment may be designated by a color (e.g., red, yellow or green) in which the headline is written.

According to one exemplary embodiment, the content screen 815 displays content, such as advertisements. In the example illustrated in FIG. 8, the advertisement displayed by the content screen 815 is “Lenovo Blog-Lenovo news previews 09” The content screen 815 as shown in FIG. 8 also displays “lenovo.com/2009,” which corresponds to an html link that may be activated by a user of the user digital device that is displaying exemplary screenshot 800.

The real-time content view screen 820, according to various exemplary embodiments, displays a portion of real-time content corresponding to a headline selected from the real-time content screen 810. In the example illustrated in FIG. 8, the portion of the real-time content displayed in the real-time content view screen 820 pertains to the selected headline of “TV: Best bets.” The real-time content view screen 820 displays additional information about various recommended programs appearing on television for a particular period of time.

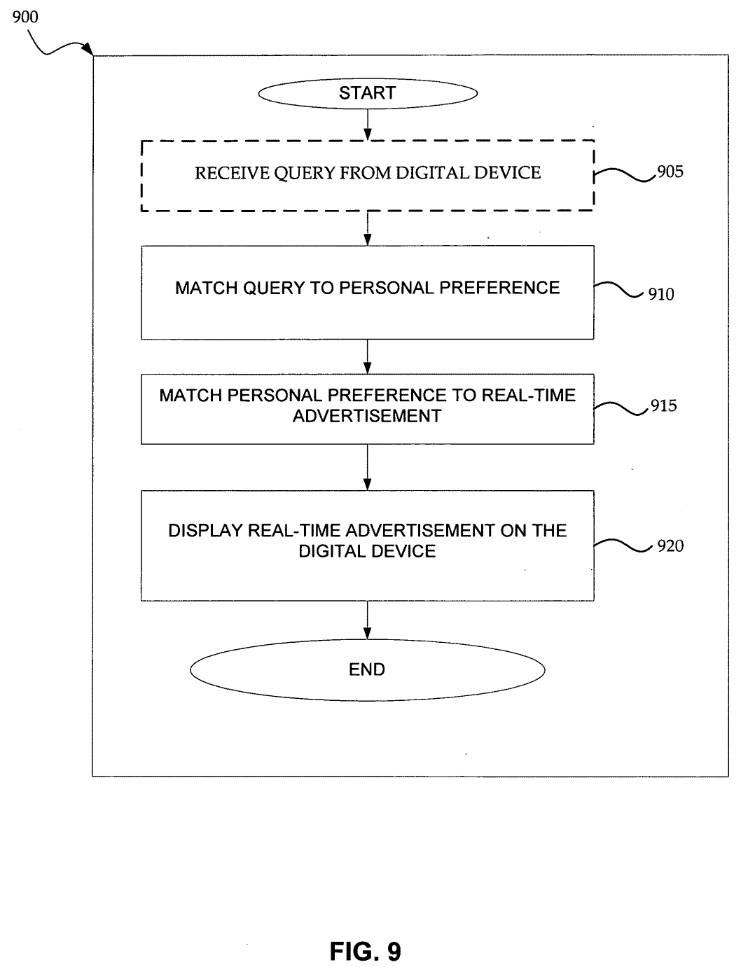

FIG. 9 is a flow chart showing another exemplary method 900 for delivering content.

At optional step 905, a query is received. According to various exemplary embodiments, the query may comprise a GPS location of a user digital device.

At step 910, the query is matched to a personal preference associated with a user of a digital device. In one exemplary embodiment, the personal preference may include the user's gender, age, income, interest or any combination thereof.

According to a further exemplary embodiment, a personal preference may be further tailored for a user of a digital device by the user requesting an alert. For instance, an alert may be requested by a user of a digital device based upon a velocity of a particular action. For example, if within a thirty-second period of time one million digital device users request to be alerted about the occurrence of a particular event, the user of the digital device may request that they receive an alert informing them about the high demand of other users requesting the particular alert. The user of the digital device may also request to receive the same alert about the particular event.

An alert may be requested by a user of a digital device based upon a periodicity of a particular event. For example, the user of the digital device may request that they receive an alert about their birthday once a year, while they may request to receive an alert about their child's soccer game once a week, or to receive an alert to buy groceries every few days, and so on.

An alert may be requested by a user of a digital device based upon a type of event or kind of event. For example, a user of a digital device may request that they receive a particular type or frequency of an alert for a scheduled event, another type or frequency of an alert for a surprise or emergency event, and so forth.

An alert mode may be requested by a user of a digital device. For example, the user of the digital device may request that they receive one type of alert via SMS, another type of alert via RSS, as well as having the other optional modes of receiving alerts via email, via telephone call, etc. An alert may be requested by a user of a digital device based upon when to interrupt the user. For example, the user may request that they immediately receive an alert in the event of an emergency, or when there is a particular item selling at a predetermined price at a predetermined time (e.g., a particular mobile phone on sale at a fifty percent discount on a weekend day).

An alert may be requested by a user of a digital device based upon a personal profile of a person attempting to contact the user of the digital device. For example, the user may request that they immediately receive an alert from a family member, or from anyone calling from Hollywood. Alternatively, the user may request that they never receive an alert from a used car salesperson.

At step 915, the personal preference is matched to real-time content. In this particular example, the personal preference may be matched to a real-time advertisement. For example, a personal preference of an interest in music may be matched to a real-time advertisement for tickets to a nearby rock concert scheduled to start within a relatively short period of time.

At step 920, the real-time advertisement is displayed on the user's digital device. For instance, the real-time advertisement for the tickets to the nearby rock concert described in step 915 may be displayed on the user's Apple iPhone.

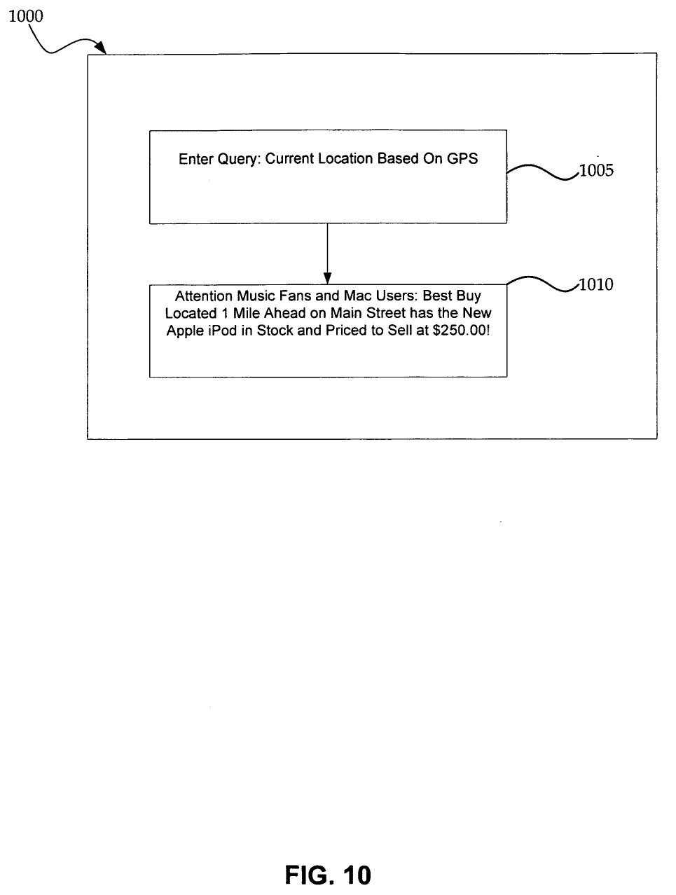

FIG. 10 illustrates an exemplary screenshot 1000 of a display on a user digital device interacting with one of the embodiments illustrated and discussed in connection with FIG. 9 herein. FIG. 10 shows a query screen 1005, and a real-time content (i.e. advertisement) screen 1010.

According to one exemplary embodiment, a query may be entered on query screen 1005. In the example shown in FIG. 10, a query of a user's current location based on a GPS position of the user's digital device is automatically generated per a program and sent by the user's digital device.

The real-time content (i.e. advertisement) screen 1010, according to various exemplary embodiments, displays a real-time advertisement. In the example illustrated in FIG. 10, the real-time advertisement displayed by the real-time content screen 1010 is “Attention Music Fans and Mac Users: Best Buy Located 1 Mile Ahead on Main Street has the New Apple iPod in Stock and Priced to Sell at $250.00!” In the example illustrated in FIG. 10, the real-time advertisement displayed by the real-time content screen 1010 is based upon the query of the user's GPS location being matched to the user's personal preference of an interest in music and Apple products.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

1. A method for delivering content, the method comprising:
receiving a query;
selecting a search result based upon a predefined velocity value;
computing a sentiment corresponding to a topic associated with the selected search result;
finding a sentiment having a specified relationship to a threshold and corresponding to content related to the topic associated with the selected search result; and
transmitting the content to a digital device for display therein.

2. The method of claim 1, wherein the predefined velocity value is measured as a point closest in time to when the search result was generated, edited, or modified relative to when the query was received.

3. The method of claim 1, the method further comprising:
transmitting at least a portion of the selected search result to the digital device for display therein.

4. The method of claim 1, wherein the content comprises text, audio, a link, video or any combination thereof.

5. The method of claim 1, wherein the received query is a name of an event, a company name, a stock ticker, a sector name, an industry name, a group name, a product name or any combination thereof.

6. The method of claim 1, the method further comprising:
selecting a search result based upon a characteristic of the search result.

7. The method of claim 6, wherein the characteristic is a mainstream media search result, a blog search result, a news wire search result, an advertisement search result or any combination thereof.

8. The method of claim 1, the method further comprising:
selecting a search result based upon a language used in the search result.

9. The method of claim 8, wherein the language is French, Japanese, Chinese, Spanish, German or English.

10. The method of claim 1, the method further comprising:
selecting a search result based upon a type of device used to submit the query.

11. The method of claim 10, wherein the type of the device used is a computing device, a laptop computer, a desktop computer, or a mobile communications device.

12. The method of claim 1, the method further comprising:
selecting a search result generated by a person other than a person that submitted the query, the search result generated in direct response to the query.

13. The method of claim 1, the method further comprising:
selecting a search result generated by an entity having a social relationship to an entity that submitted the query.

14. The method of claim 1, the method further comprising:
determining whether the transmitted content was accessed.

15. The method of claim 14, the method further comprising:
generating data describing the content accessed; and
computing a sentiment corresponding to a topic associated with the content accessed.

16. A system for content delivery, the system comprising:
an interface module configured to receive a query;
a search engine in communication with the interface module, the search engine configured to select a search result based upon a predefined velocity value;
a processing component in communication with the search engine, the processing component configured to compute a sentiment corresponding to a topic associated with the selected search result, to find a sentiment having a specified relationship to a threshold and corresponding to content related to the topic associated with the selected search result; and
a transmission module in communication with the processing component, the transmission module configured to transmit the content to a digital device for display therein.

17. The system of claim 16, wherein the predefined velocity value is measured as a point closest in time to when the search result was generated, edited, or modified.

18. A system for content delivery, the system comprising:
a processor;
a computer readable storage medium having instructions for execution by the processor which causes the processor to deliver content;
wherein the processor is coupled to the computer readable storage medium, the processor executing the instructions on the computer readable storage medium to:
receive a query;
select a search result based upon a predefined velocity value;
compute a sentiment corresponding to a topic associated with the selected search result;
find a sentiment having a specified relationship to a threshold and corresponding to a topic related to content associated with the selected search result; and
transmit the content to a digital device for display therein.

19. The system of claim 18, wherein the predefined velocity value is measured as a point closest in time to when the search result was generated, edited, or modified.

20. A method for selecting a search result for generation of content for transmission to a digital device for display therein, the method comprising:
selecting from multiple search results a search result based upon a predefined velocity value;
computing a sentiment corresponding to a topic associated with the selected search result;
finding a sentiment having a specified relationship to a threshold and corresponding to content related to the topic associated with the selected search result; and
transmitting the content to the digital device for display therein.

21. The method of claim 20, wherein the selected search result originated from a networked sensor.

22. The method of claim 21, wherein the networked sensor is a GPS device, card key reader, credit card reader, or game console.

23. The method of claim 20, wherein the predefined velocity value is measured as a point closest in time to when the search result was generated, edited, or modified.

24. A system for selecting a search result for generation of content for transmission to a digital device for display therein, the system comprising:
a search engine configured to select from multiple search results a search result based upon a predefined velocity value;
a processing component in communication with the search engine, the processing component configured to compute a sentiment corresponding to a topic associated with the selected search result, to find a sentiment having a specified relationship to a threshold and corresponding to content related to the topic associated with the selected search result; and
a transmission module in communication with the processing component, the transmission module configured to transmit the content to the digital device for display therein.

25. The system of claim 24, wherein the predefined velocity value is measured as a point closest in time to when the search result was generated, edited, or modified relative to when the query was received.

26. A computer readable storage medium having a computer readable code for operating a computer to perform a method for selecting a search result for generation of content for transmission to a digital device for display therein, the method comprising:
selecting from multiple search results a search result based upon a predefined velocity value;
computing a sentiment corresponding to a topic associated with the selected search result;
finding a sentiment having a specified relationship to a threshold and corresponding to content related to the topic associated with the selected search result; and
transmitting the content to the digital device for display therein.

27. The computer readable storage medium of claim 26, wherein the predefined velocity value is measured as a point closest in time to when the search result was generated, edited, or modified.

28. The computer readable storage medium of claim 26, wherein the selected search result originated from a networked sensor.

29. The computer readable storage medium of claim 28, wherein the networked sensor is a GPS device, card key reader, credit card reader, or game console.

30. The computer readable storage medium of claim 26, wherein the content includes a link to a third-party web site.

31. The computer readable storage medium of claim 26, the method further comprising:
transmitting the computed sentiment to the digital device for display therein as a color of red, yellow, or green.

32. A method for delivering advertisements, the method comprising:
receiving a query;
matching the query to real-time content;
matching the real-time content to an advertisement; and
transmitting the advertisement to a digital device for display therein.

33. The method of claim 32, wherein the real-time content is generated, edited, or modified within seven days of when the query was received.

34. The method of claim 32, the method further comprising:
transmitting at least a portion of the real-time content to the digital device for display therein.

35. A method for delivering advertisements, the method comprising:
receiving a query from a digital device;
matching the query to a personal preference associated with a user of the digital device;
matching the personal preference to a real-time advertisement; and
transmitting the real-time advertisement to the digital device for display therein.

36. The method of claim 35, wherein the personal preference is the user's gender, age, income, interest or any combination thereof.

37. A method for delivering advertisements, the method comprising:
receiving a query from a digital device;
matching the query to real-time content;
matching the query to a personal preference associated with a user of the digital device;
matching the real-time content and the personal preference to a real-time advertisement; and
transmitting the real-time advertisement to the digital device for display therein.
